(19) United States
(12) Patent Application Publication
(10) Pub. No.: US 2026/0058906 A1
(43) Pub. Date: Feb. 26, 2026

(54) MULTI-SEGMENTS SD-WAN VIA CLOUD DCS TRANSIT NODES

(71) Applicant: HUAWEI TECHNOLOGIES CO., LTD., Shenzhen (CN)

(72) Inventor: Linda Dunbar, Plano, TX (US)

(21) Appl. No.: 19/376,423

(22) Filed: Oct. 31, 2025

Related U.S. Application Data
(63) Continuation of application No. PCT/US2024/027743, filed on May 3, 2024.
(60) Provisional application No. 63/499,850, filed on May 3, 2023.

(51) Int. Cl. H04L 45/74; H04L 9/40; H04L 12/46; H04L 12/66; H04L 69/164; H04L 69/22

(52) U.S. Cl. CPC H04L 45/74; H04L 12/4633; H04L 12/66; H04L 63/0485; H04L 69/164; H04L 69/22; H04L 2212/00

(57) ABSTRACT

A method implemented by a first cloud gateway (GW). The method includes receiving, from a first customer premises edge (CPE) on a Software-Defined Wide Area Network (SD-WAN) path, a packet comprising an outer Internet Protocol (IP) header and a generic network virtualization encapsulation (GENEVE) header. The GENEVE header includes one or more sub-type length values (TLVs). The method further includes extracting a destination address from the one or more sub-TLVs within the GENEVE header. The method also includes updating a destination IP address in the outer IP header with the extracted destination address and forwarding the packet to the second CPE based on the updated IP destination address.

### CROSS-REFERENCE TO RELATED APPLICATIONS

This is a continuation of International Patent Application No. PCT/US2024/027743 filed on May 3, 2024, which claims priority to U.S. Provisional Patent Application No. 63/499,850 filed on May 3, 2023, which are hereby incorporated by reference in their entireties.

### TECHNICAL FIELD

The present application is generally related to Software-Defined Wide Area Network (SD-WAN), and in particular, to optimize stitching of multiple SD-WAN segments on cloud gateways/transit nodes across cloud data centers (DCs).

### BACKGROUND

SD-WAN offers a streamlined and efficient way for linking an enterprise's on-premises customer premises equipment's (CPEs) and private virtual private networks (VPNs) with services in cloud DCs. Various methods like Segment Routing over Internet Protocol version 6 (IPv6) (SRv6) or Multiprotocol Label Switching (MPLS)-Traffic Engineering (TE) are available to steer traffic through designated nodes. Those traffic steering methods are effective when the entire network domain is under one administrative control. However, the traffic from on-premises CPEs to cloud gateways (GWs) via the public internet relies solely on forwarding based on the packets' destination addresses.

### SUMMARY

The disclosed aspects/embodiments provide methods for SD-WAN CPEs that employ a generic network virtualization encapsulation (GENEVE) encapsulation to encapsulate the Internet Protocol Security (IPsec) encrypted packets and direct them towards the nearest cloud GWs. These cloud GWs are capable of determining, without decryption, whether a packet should traverse the cloud backbone by inspecting sub-Type-Length-Values (TLVs) within a GENEVE header. Once it is established that that the packet is destined for backbone traversal, the IPsec encrypted payload is steered through the cloud backbone without decryption to optimal egress cloud GWs. These gateways then forward the original IPsec encrypted payload to the destination CPEs. The disclosed methods facilitate the connection of multiple segments of SD-WAN through the cloud backbone without requiring the cloud GWs to decrypt and re-encrypt the payloads.

Furthermore, by directing encrypted traffic through the cloud backbone without the necessity for decryption and subsequent re-encryption at cloud GWs, processing demands at these GWs may be significantly reduced. This streamlined approach maintains the integrity of the encrypted traffic, optimizes processing resources, and enhances overall efficiency of the cloud infrastructure.

A first aspect relates to a method implemented by a first cloud gateway (GW), the method comprising: receiving, from a first customer premises edge (CPE) on a Software-Defined Wide Area Network (SD-WAN) path, a packet comprising an outer Internet Protocol (IP) header and a generic network virtualization encapsulation (GENEVE) header, wherein the GENEVE header includes one or more sub-type length values (TLVs); extracting a destination address from the one or more sub-TLVs within the GENEVE header; updating a destination IP address in the outer IP header with the extracted destination address; and forwarding the packet to the second CPE based on the updated IP destination address.

Optionally, in any of the preceding aspects, another implementation of the aspect provides that the one or more sub-TLVs comprise a SD-WAN Endpoint sub-TLV, and wherein the SD-WAN Endpoint sub-TLV comprises the destination address of the second CPE.

Optionally, in any of the preceding aspects, another implementation of the aspect further comprising updating a source IP address in the outer IP header with an address of the first cloud GW based on determining to forward the packet to the second CPE; and forwarding the packet to the second CPE based on the updated source IP address and the updated IP destination address.

Optionally, in any of the preceding aspects, another implementation of the aspect provides that before forwarding the packet to the second CPE, the method further comprising determining to forward the packet to the second cloud GW based on policy of a cloud operator.

Optionally, in any of the preceding aspects, another implementation of the aspect further comprising determining whether the one or more sub-TLVs include an egress-GW sub-TLV; extracting a second destination address of the second cloud GW from the egress-GW Sub-TLV based on determining the one or more sub-TLVs include the egress-GW sub-TLV; updating a source IP address in the outer IP header with an address of the first cloud GW; and forwarding the packet to the second cloud GW based on the updated source IP address and the second destination address.

Optionally, in any of the preceding aspects, another implementation of the aspect provides that the first CPE uses GENEVE encapsulation to encapsulate the packet, and wherein the packet is an Internet Protocol Security (IPsec) encrypted packet.

Optionally, in any of the preceding aspects, another implementation of the aspect further comprising establishing a bidirectional Internet Protocol Security (IPsec) tunnel between the second cloud GW and the second CPE to forward the packet to the second CPE.

Optionally, in any of the preceding aspects, another implementation of the aspect provides that the GENEVE header is encapsulated in a user datagram protocol (UDP) header.

Optionally, in any of the preceding aspects, another implementation of the aspect provides that the GENEVE header comprises variable length options field, and wherein the variable length options field comprises an option class field, a type field, and variable options data field.

Optionally, in any of the preceding aspects, another implementation of the aspect provides that the option class field comprises a multi-seg-SD-WAN option class, and wherein a type field indicates a type of multi-segment SD-WAN.

Optionally, in any of the preceding aspects, another implementation of the aspect provides that the variable length options field comprises the one or more sub-TLVs, wherein the one or more sub-TLVs include an SD-WAN Endpoint sub-TLV and optional sub-TLVs, and wherein optional sub-TLVs include an SD-WAN tunnel originator sub-TLV and/or an Egress GW Sub-TLV.

Optionally, in any of the preceding aspects, another implementation of the aspect provides that the SD-WAN Endpoint sub-TLV comprises a length field and a Time to live (TTL) field indicating a number of cloud GWs traversed by the packet.

Optionally, in any of the preceding aspects, another implementation of the aspect provides that the SD-WAN tunnel originator sub-TLV indicates an IP address of the first CPE.

Optionally, in any of the preceding aspects, another implementation of the aspect provides that the Egress GW sub-TLV indicates an address of the second cloud GW for reaching the second CPE.

Optionally, in any of the preceding aspects, another implementation of the aspect further comprising performing authentication on the packet using preconfigured authentication methods.

Optionally, in any of the preceding aspects, another implementation of the aspect provides that the first cloud GW is in a first cloud data center, and the second cloud GW is in a second cloud data center.

A second aspect relates to a method implemented by a first customer premises edge (CPE), the method comprising: receiving a packet, wherein the packet is an Internet Protocol Security (IPsec) encrypted packet; encapsulating the packet using a generic network virtualization encapsulation (GENEVE) encapsulation to generate an encapsulated packet, wherein the encapsulated packet comprises a GENEVE header including one or more sub-type length values (TLVs); and forwarding, on a Software-Defined Wide Area Network (SD-WAN) path and through a cloud gateway (GW), the encapsulated packet to a second CPE.

Optionally, in any of the preceding aspects, another implementation of the aspect provides that the one or more sub-TLVs comprise a SD-WAN Endpoint sub-TLV, and wherein the SD-WAN Endpoint sub-TLV comprises a destination address of the second CPE.

Optionally, in any of the preceding aspects, another implementation of the aspect further comprising enabling the cloud GW to extract the destination address of the second CPE from the one or more sub-TLVs within the GENEVE header.

Optionally, in any of the preceding aspects, another implementation of the aspect provides that the one or more sub-TLVs include an SD-WAN tunnel originator sub-TLV indicating an address of the first CPE or an Egress GW Sub-TLV.

Optionally, in any of the preceding aspects, another implementation of the aspect provides that the encapsulated packet further comprises an outer IP header, and wherein the outer IP header comprises a destination address indicating an address of the first cloud.

Optionally, in any of the preceding aspects, another implementation of the aspect further comprising establishing an Internet Protocol Security (IPsec) tunnel between the first CPE and the second CPE to forward the packet to the second CPE.

A third aspect relates to a cloud gateway, comprising: a memory storing instructions; and one or more processors coupled to the memory and configured to execute the instructions to cause the cloud gateway to the method of the first aspect.

A fourth aspect relates to a non-transitory computer readable medium comprising a computer program product for use by a cloud gateway (GW), the computer program product comprising computer executable instructions stored on the non-transitory computer readable medium that, when executed by one or more processors, cause the cloud gateway (GW), to execute the method of the first aspect.

A fifth aspect relates to a cloud gateway (GW), comprising one or more means for performing the method of the first aspect.

A sixth aspect relates to a first customer premises edge (CPE), comprising: a memory storing instructions; and one or more processors coupled to the memory and configured to execute the instructions to cause the first customer premises edge (CPE), to the method of the second aspect.

A seventh aspect relates to a non-transitory computer readable medium comprising a computer program product for use by a first customer premises edge (CPE), the computer program product comprising computer executable instructions stored on the non-transitory computer readable medium that, when executed by one or more processors, cause the first customer premises edge (CPE), to execute the method of the second aspect.

An eighth aspect relates to a first customer premises edge (CPE), comprising one or more means for performing the method of the second aspect.

For the purpose of clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A is a schematic diagram illustrating an example multi-segment SD-WAN stitching via a single cloud GW according to an embodiment of the present disclosure.

FIG. 1B is a schematic diagram illustrating an example multi-segment SD-WAN stitching via cloud backbone according to an embodiment of the present disclosure.

FIG. 2A is a schematic diagram illustrating a format of a GENEVE packet for a single hop cloud GW according to an embodiment of the present disclosure.

FIG. 2B is a schematic diagram illustrating a format of a GENEVE packet for multi-hop cloud GWs according to an embodiment of the present disclosure.

FIG. 3 is a schematic diagram illustrating a format of a GENEVE header according to an embodiment of the present disclosure.

FIG. 4 is a schematic diagram illustrating a format of multi-segment SD-WAN option class according to an embodiment of the present disclosure.

FIG. 5 is a schematic diagram illustrating a format of a SD-WAN endpoint sub-TLV according to an embodiment of the present disclosure.

FIG. 6A is a schematic diagram illustrating a format of a SD-WAN tunnel origin endpoint sub-TLV according to an embodiment of the present disclosure.

FIG. 6B is a schematic diagram illustrating a format of a SDWAN Egress GW Sub-TLV according to an embodiment of the present disclosure.

FIG. 7A is a flowchart illustrating a method performed by a cloud GW according to an embodiment of the present disclosure.

FIG. 7B is a flowchart illustrating a method performed by a first CPE according to an embodiment of the present disclosure.

FIG. 8 is a schematic diagram illustrating a network element according to an embodiment of the present disclosure.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

A SD-WAN is a convenient and efficient way to connect on-premises CPEs with services in cloud DCs. There are multiple options for enterprises to connect to cloud DCs such as 1) Direct interconnect model, 2) Direct interconnect model with enterprise's virtual appliances in the cloud, 3) Indirect interconnect model via SD-WAN paths, and 4) Managed hybrid WAN model using enterprise's existing VPN connections. For enterprise branches utilizing private VPN circuits to connect with a cloud GW via internet exchange points (IXPs), extending into cloud DCs can be achieved without establishing IPsec paths between the on-premises CPEs and the cloud GWs. SD-WAN allows for the setup of multiple links (a.k.a paths) from the same SD-WAN branch CPE to a Cloud GW, wherein each link represents a dual tunnel connection from a unique public IP of the SD-WAN CPE to two different instances of Cloud GW. Using Cloud GW to interconnect those on-prem CPEs eliminates the need to manage the multiple ISPs' links/paths between the CPEs.

To ensure security, traffic between CPEs within the enterprise remains encrypted and inaccessible to external parties, including the cloud DC. In order for encrypted packets to pass through the cloud DC, the packet header includes information indicating the intendent route of the packet. Since the IPsec security association (SA) between CPEs is maintained exclusively between them and is not accessible to cloud GWs, the encrypted packet needs to travel through a tunnel between the source CPE and an ingress cloud GW. This tunnel may involve an additional layer of IPsec, which increases the processing overhead on the cloud GW for decrypting the outer IPsec tunnel solely for steering the encrypted payload.

The present disclosure presents techniques to integrate or stitch multiple SD-WAN segments via transit nodes across cloud DCs. Embodiments of a stitching architecture are realized by CPEs that employ a GENEVE encapsulation to encapsulate the IPsec encrypted packets and direct them towards the nearest cloud GWs. These gateways are capable of determining, without decryption, whether a packet should traverse the cloud backbone by inspecting sub-TLVs within the GENEVE header. Once it is established that that the packet is destined for backbone traversal, the IPsec encrypted payload is steered through the cloud backbone without decryption to optimal egress cloud GWs. These gateways then forward the original IPsec encrypted payload to the destination CPEs. The disclosed methods facilitate the connection of multiple segments of SD-WAN through the cloud backbone without requiring the cloud GWs to decrypt and re-encrypt the payloads.

Furthermore, by directing encrypted traffic through the cloud backbone without the necessity for decryption and subsequent re-encryption at cloud GWs, processing demands at these GWs may be significantly reduced. This streamlined approach maintains the integrity of the encrypted traffic, optimizes processing resources, and enhances overall efficiency of the cloud infrastructure.

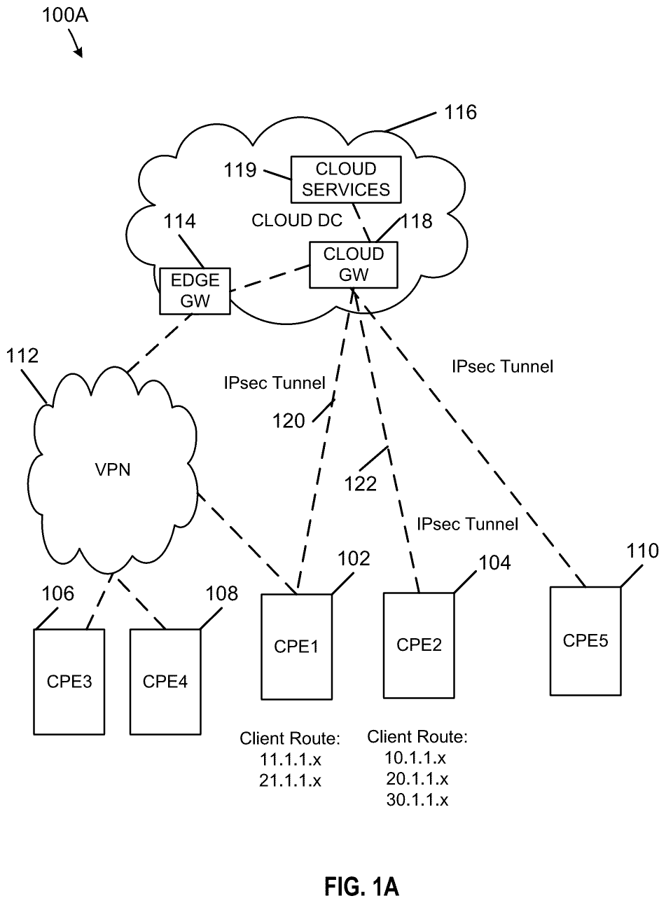

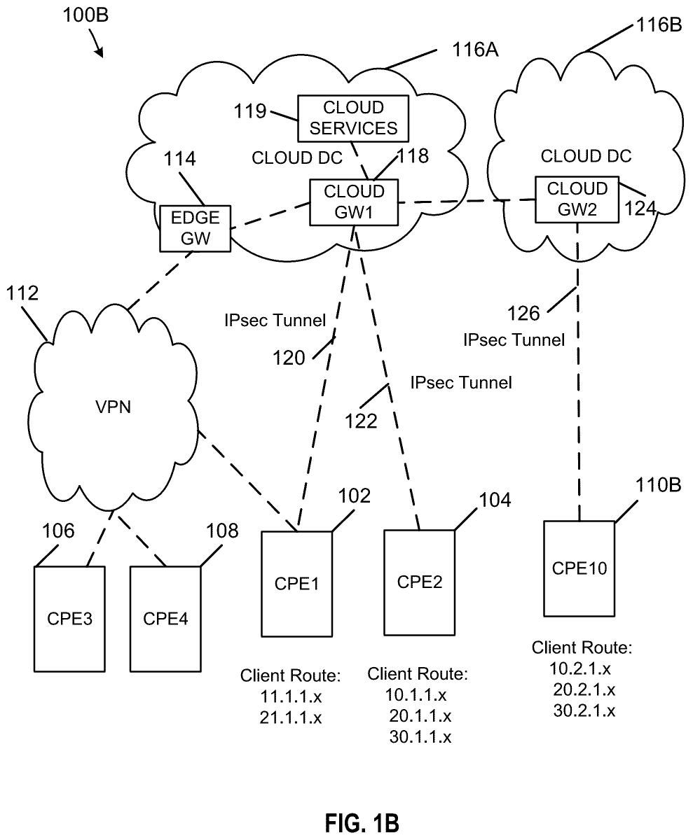

FIG. 1A is a schematic diagram illustrating an example multi-segment SD-WAN stitching via a single cloud GW according to an embodiment of the present disclosure. As shown, an SD-WAN network 100A includes a plurality of CPEs 102-110, a VPN 112, an edge GW 114, and a cloud DC 116 (often referred to as a data center or the cloud) comprising a cloud GW 118 (often referred to as a transit node) connected to cloud services 119 (for example, a virtual network (VNet) or a virtual private cloud (VPC)). While five CPEs 102-110 are shown in the network 100A, more or fewer CPEs may be included in practical applications. For ease of discussion, all of the CPEs 102-110 have been given a letter designation. For example, a first CPE 102 has the designation CPE1, a second CPE 104 has the designation CPE2, a third CPE 106 has the designation CPE3, a fourth CPE 108 has the designation CPE4, and a fifth CPE 110 has the designation CPE5. In an embodiment, the CPE1-CPE5 may be network devices (e.g., routers or client gateway devices) located at a customer (e.g., end-user) site or various branch offices of an enterprise that connect to the cloud DC 116 to provide certain functions; namely, IPSec encryption, routing functionality, and/or SD-WAN functions.

In an embodiment, the edge GW 114 may connect with the cloud GW 118 through one or more secure connections. In an embodiment, one or more of the CPEs, CPE1-CPE5, may connect to the edge GW 114 and VPN 112 through one or more provider networks. Alternatively, in an embodiment, one or more of the CPEs, CPE1-CPE5, may connect to the VPN 112 over a public Internet using a secure tunnel (e.g., using Internet Protocol Security (IPsec)) to establish secure connection to the VPN 112. Although only one edge GW 114 and VPN 112 are illustrated in FIG. 1A, the cloud DC 116 may have multiple edge GWs and VPNs. The edge GW 114 functions as a termination end-point for VPN connections initiated from the CPEs 102-110, provides routing functions, and provides Quality-of-Service (QoS) for packets entering and leaving the VPN 112.

In an embodiment, the VPN 112 is in communication with the CPEs 102-110 via IXP to connect the CPEs to the cloud GW 118. For example, the cloud GW 118 connects client traffic from the CPE1 via the VPN 112 to the CPE2 via an IPsec tunnel. In another embodiment, the cloud GW 106 connects client traffic directly from the CPE1 to the CPE2 via the IPsec tunnel. The IPsec tunnels can be established between the CPEs 102-110, the edge GW 114, or the cloud GW 118 to create secure communication channels. These IPsec tunnels encrypt data traffic between endpoints. To ensure the confidentiality, integrity, and availability of communication among the CPEs 102-110, the traffic between the CPEs 102-110 should be encrypted by the IPsec Security Associations (SAs) when traversing the public Internet. In one embodiment, the IPsec tunnel is a bidirectional IPsec tunnel 120 between the CPE1 and the cloud GW 118 using a first IPSec SA1 for the traffic from the CPE1 to the cloud GW 118 and a second IPSec SA2 for the traffic from the cloud GW 118 to the CPE1. In an embodiment, the IPsec tunnel is a bidirectional IPsec tunnel 122 between CPE2 and the cloud GW 118 using a third IPSec SA3 for the traffic from the CPE2 to the cloud GW 118 and a fourth IPSec SA4 for the traffic from the cloud GWPY 118 to the CPE2. In an embodiment, when a packet/client traffic with address prefix 11.1.1.x of source CPE1 needs transfer to the destination CPE2 with address prefix 10.1.1.x, the CPE1 and the CPE2 may establish a bidirectional IPsec tunnel using a fifth IPSec SA5 for the traffic from the CPE1 to the CPE2 and a sixth IPSec SA6 for the traffic from the CPE2 to the CPE 1.

From the foregoing, it should be understood that, the communication between CPEs is encrypted using IPsec SAs while traversing through the public Internet to maintain confidentiality, integrity, and availability. As such, when the traffic between the enterprise's CPEs doesn't terminate within the cloud DC 116, the processing burden on cloud GW 118 can be significantly reduced if the cloud GW 118 do not need to decrypt and re-encrypt transit IPsec encrypted traffic among CPEs. This discourse describes the mechanisms for the IPsec encrypted traffic between CPEs 102-110 to traverse the cloud GW 118 without being decrypted and re-encrypted by the cloud GW 118.

For the purposes of discussion, assume that all CPEs 102-110 are under one Internal Border Gateway Protocol (iBGP) administrative domain to enable more efficient and effective routing decisions and to provide greater control over traffic flow and security. In one embodiment, a Route Reflector (RR) controller may be configured to provide route exchange between the CPEs.

FIG. 1B is a schematic diagram illustrating an example multi-segment SD-WAN stitching via cloud backbone according to an embodiment of the present disclosure. As shown in FIG. 1B, the geographic faraway enterprise branches (such as CPEs) have established SD-WAN paths within an SD-WAN network 100B to connect to their corresponding cloud GWs for accessing cloud services in different geographic locations or cloud DC sites. The cloud backbone may be utilized to interconnect these branches together. The reasons to utilize the cloud backbone to interconnect those branches are similar to interconnecting multiple branches via a single cloud GW as described above. As shown in FIG. 1B, the SD-WAN network 100B comprises a plurality of cloud data centers such as 116A and 116B. Each of the cloud data centers 116A and 116B has a respective cloud GW1 118 and cloud GW2 124. While two cloud DCs 116A and 116B are shown in the network 100B, more or fewer cloud DCs may be included in practical applications. The behavior of components of SD-WAN network 100B depicted in FIG. 1B are similar to the behavior of components of SD-WAN network 100A depicted in FIG. 1A. For the sake of brevity, a detailed description of these elements is not repeated herein.

In one embodiment, the traffic to/from geographic apart CPEs (such as CPE1 and CPE10) can cross multiple cloud GWs via cloud backbone. As shown in FIG. 1B, the IPsec tunnels can be established between the CPEs 102-108 and 110B, the edge GW 114, or the cloud GWs 118 and 124 to create secure communication channels. The on-prem CPEs are aware of each other's addresses and the address of the nearest cloud GW. The intermediate cloud GWs within cloud DCs that do not have access to on-Prem CPEs can be hidden from the CPEs. IPsec tunnel can be established between CPEs. These IPsec tunnels encrypt data traffic between endpoints. To ensure the confidentiality, integrity, and availability of communication among the CPEs, the traffic between the CPEs should be encrypted by the IPsec SAs if traversing the public Internet. In an embodiment, the IPsec tunnel is a bidirectional IPsec tunnel 120 between the CPE1 and the cloud GW 118 using a first IPSec SA1 for the traffic from the CPE1 to the cloud GW 118 and a second IPSec SA2 for the traffic from the cloud GW 118 to the CPE1. In an embodiment, the IPsec tunnel is a bidirectional IPsec tunnel 126 between CPE10 and the cloud GW2 124 using a third IPSec SA3 for the traffic from the CPE10 to the cloud GW 124 and a fourth IPSec SA4 for the traffic from the cloud GW 124 to the CPE10. In an embodiment, when a packet/client traffic with address prefix 11.1.1.x of source CPE1 transfers to destination CPE2 with address prefix 10.1.1.x, CPE1 and CPE10 may establish a bidirectional IPsec tunnel using a fifth IPSec SA5 for the traffic from the CPE1 to the CPE10 and a sixth IPSec SA6 for the traffic from the CPE10 to the CPE1. As shown in FIG. 213, the traffic from CPE1 to CPE10 ingress into the cloud DC 116A via cloud GW1 118 and egress the cloud DC 116A via cloud GW2 124 towards CPE10. Multiple cloud GWs between cloud GW1 and cloud GW2 are not visible to the CPEs.

For the purposes of discussion, assume that all CPEs 102-108 and 110B are under one iBGP administrative domain to enable more efficient and effective routing decisions and to provide greater control over traffic flow and security. In on embodiment, a Route Reflector (RR) controller may be configured to provide route exchange between the CPEs. The CPEs notify their peers of their corresponding cloud GW addresses.

In general, it is important for cloud GWs 118, 124 to mark the packet headers correctly in order to differentiate between packets that need decryption for internal hosts/services and transit packets that should be forwarded to destination branch CPEs. In this disclosure, GENEVE encapsulation, which is widely supported by most cloud service providers, is chosen as the encapsulation header for cloud GWs to route IPsec encrypted packets among CPEs without requiring decryption. In an embodiment, there may be other types of encapsulation headers (for example, Segment Routing Header (SRH), UDP Option Header, etc.) for cloud GWs to route IPsec encrypted packets among CPEs without requiring decryption.

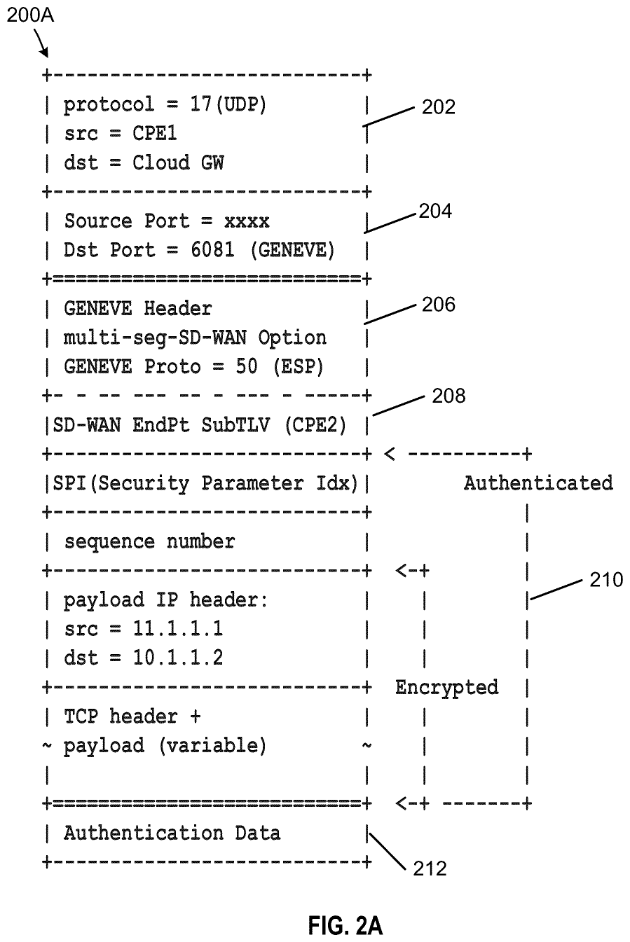

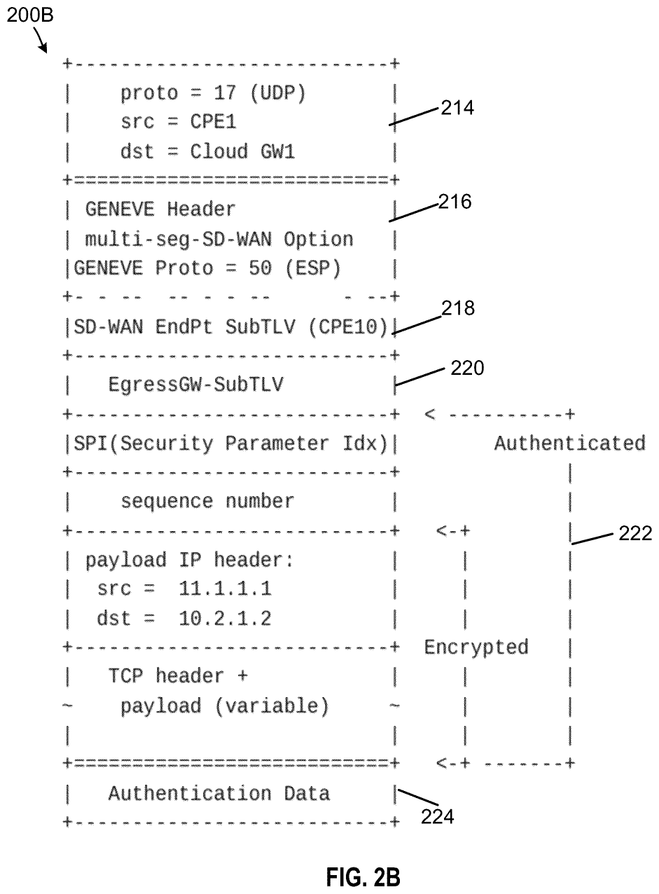

FIG. 2A is a schematic diagram illustrating a packet header 200A of a packet for a single hop cloud GW according to an embodiment of the present disclosure. The cloud GW 118 (as shown in FIG. 1A) is capable of understanding the packet header 200A of the packet, but does not originate or terminate packets. Only tunnel endpoints perform encapsulation and decapsulation of packets, such as Ethernet frames or IP datagrams, in GENEVE headers. The GENEVE tunneling protocol, as described in the disclosed methods is designed to provide control-plane independence between tunnel endpoints in a virtualized network environment. This protocol allows for the inclusion of metadata encoded in a TLV format as option headers, enabling flexibility for current and future network. As shown in FIG. 1A, the cloud GW 118 connects client traffic/forward data packets from the CPE1 to the CPE2 via the IPsec tunnels. The CPE1 initiates the communication by generating GENEVE encapsulated packets destined for CPE2.

As shown in FIG. 2A, when CPE1 initiates communication with CPE2, it encapsulates a received IP packet to generate an encapsulated packet. The encapsulated packet comprising an outer IP header 202 with an outer user datagram protocol (UDP) header 204, a GENEVE header 206 followed by a set of variable-length options field 208, an encapsulating security payload (ESP) header 210, and authentication data 212 as they traverse through the SD-WAN network (e.g., network 100A). The outer IP header 202 comprising a source IP address indicating the IP address of the sender, a destination IP address indicating IP address of the indented recipient, and a protocol indicating the protocol used in the data portion of the packet. As such, the CPE1 sets its own IP address as the source IP address, CPE2's IP address as the destination IP address, and specifies the protocol as UDP with a value 17 in the outer IP header 202. The value 17 indicates that the data portion of the packet is using the UDP protocol for communication. The outer IP header is followed by the outer UDP header 204. The outer UDP header 204 comprising a source port selected by the originating tunnel endpoint (i.e., CPE1) and a destination port. The source port should be the same for all packets belonging to a single encapsulated flow to prevent reordering to the use of different paths. The destination port has assigned port number 6081 to indicate that the packet is GENEVE encapsulated. By assigning port number 6081 to the destination port, the cloud GWs can recognize that the incoming packet is GENEVE encapsulated and process it accordingly. The GENEVE header 206 encapsulated in the UDP header 204 over either IP version 4 (IPv4) or IP version 6 (IPv6).

The GENEVE header 206 is a tunnel header that comprises fields including a Variable-Length Option class and a protocol type. As shown in FIG. 2A, the Variable-Length Option class comprises a new GENEVE option class dedicated for multi segment SD-WAN, i.e., a multi-seg-SD-WAN option class indicating that the multi-segment SD-WAN relevant sub-TLVs are encoded in the GENEVE header 206. The protocol type includes a value 50 to indicate that the next is the ESP header 210 to process. The GENEVE header 206 is then followed by a set of variable-length options field 208 in a TLV format. Each option consists of a 4-byte option header and a variable amount of option data interpreted according to the type. Here, a new sub-TLV, i.e., an SD-WAN-Endpoint sub-TLV is described to indicate the destination of the IPsec Tunnel. For example, for the SD-WAN IPsec SA from CPE1 to CPE2, the SD-WAN-Endpoint sub-TLV 208 of the GENEVE header 206 has the IP address of destination CPE2 (e.g., CPE2 in FIG. 1A). The standard format of the GENEVE header is described in more detail in the Internet Engineering Task Force (IETF) document Request for Comments (RFC) 8926 entitled “Geneve: Generic Network Virtualization Encapsulation” by J. Gross, et al., published November, 2020.

The GENEVE header is then further encrypted using the ESP protocol. The ESP header 210 is inserted between the outer IP header 202 and the encrypted payload IP header. The ESP header 210 comprises a Security Parameters Index (SPI) field and a sequence number field. The packet header 200A further comprises a payload IP header and the TCP header that contain encrypted data. The authentication data 212 is a variable-length field containing an integrity check value (ICV) computed over the ESP packet minus the authentication data. The standard format of the ESP header is described in more detail in the Internet Engineering Task Force (IETF) document Request for Comments (RFC) 4303 entitled “IP Encapsulating Security Payload (ESP)” by S. Kent, et al., published December, 2005.

Illustration of Traffic flow from CPE1 to CPE2

In an embodiment, the sender CPE1 examines the destination address in the outer IP header 202 of the packet, consults its routing table to determine the next hop, and forwards the packet to the cloud GW 118 via IPsec tunnel 120 as shown in FIG. 1A. In an embodiment, upon receiving the GENEVE encapsulated packet with the GENEVE Protocol Type=50 (ESP), the cloud GW 118 authenticates the packet using a preconfigured authentication method. After authentication, the cloud GW 118 terminates the outer IP header 202 and checks the address encoded in the SD-WAN Endpoint Sub-TLV 208 inside the GENEVE header 206. In an embodiment, when the address in the SD-WAN Endpoint Sub-TLV 208 is reachable without another cloud GW/transit node, the cloud GW 118 replaces the destination address in the outer IP header 202 with the address encoded in the sub-TLV (i.e. CPE2 address), updates the source IP address in the outer IP header 202 with an address of the first cloud GW and forwards the packet, based on the updated source IP address and the updated IP destination address, to the destination CPE2 through the IPSec tunnel 122, as shown in FIG. 1A. The GENEVE header 206 remains unchanged.

In an embodiment, when the cloud operator's internal policy determines that another transit node is required, the cloud GW 118 changes the destination IP address in the outer IP header 202 with an address to the next cloud GW/transit node (e.g., cloud GW2 124 as shown in FIG. 1). The process and policy of selecting the next cloud GW/transit node is internal to the cloud operator.

### Data Authentication and Integrity Check by Cloud GW/Transit Node

As the IPsec SA already encrypts the client payload between the CPEs, the cloud GW does not need to decrypt and re-encrypt the payload when relaying it to the destination CPE. However, data authentication and integrity check are needed as the traffic traverse an untrusted network and the cloud GW performs the integrity check or the digital signature for the GENEVE header portion. In an embodiment, the cloud GW 118 may drop all packets with the source addresses or the values in the sub-TLVs of the GENEVE header that are not recognized or registered to prevent unauthorized users from using the cloud services. The cloud GW 118 may validate the value of the SD-WAN Endpoint sub-TLV and drop the packet if the value of the SD-WAN Endpoint Sub-TLV is an unpaid (or unregistered) address.

Illustration of Traffic from Private VPN to IPsec Tunnel

In an embodiment, the cloud GW 118 connects client traffic from the CPE1 via the private VPN 112 to CPE2 via an IPsec tunnel. If the destination is within the VPN 112, CPE1 forwards the packet to the cloud GW via the VPN 112. Here, the packet is not encrypted. The VPN 112 forwards the packet 200A to the edge GW 114. The edge GW 114 inspects the received packet 200A and performs deep packet inspection. Once the packet has been processed and deemed safe, the edge GW 114 forwards it to the cloud GW 118. Upon receiving the GENEVE encapsulated packet with the multi-Segment-SD-WAN option 208, the cloud GW 118 extracts the destination CPE from the GENEVE header 206 and encrypts the packet with the IPsec SA2 to forward to the destination (i.e., CPE2). The GENEVE Header 206 is carried to the CPE2.

FIG. 2B is a schematic diagram illustrating a format of a packet header 200B for multi-hop cloud GWs according to an embodiment of the present disclosure. The disclosed method for SD-WAN CPEs use GENEVE Encapsulation to encapsulate the IPsec encrypted packets and send them to their closest Cloud GWs, who can steer the IPsec encrypted payload through the cloud Backbone without decryption to the egress cloud GWs which then forward the original IPsec encrypted payload to the destination CPEs. As shown in FIG. 1B, the cloud GWs 118 and 124 connect client traffic/forward data packets from the CPE1 to the CPE10 via the IPsec tunnels. The CPE1 initiates the communication by generating GENEVE encapsulated packets destined for CPE10.

As shown in FIG. 2B, when CPE1 initiates communication with CPE2, it encapsulates a received IP packet comprising an outer IP header 214 with a GENEVE header 216 followed by a set of variable-length option field 218, 220, an encapsulating security payload (ESP) header 222, and authentication data 224 as they traverse through the SD-WAN network (e.g., SD-WAN network 100B). The CPE1 sets its own IP address as the source IP address, cloud GW1 118 as the destination IP address, and specifies the protocol as UDP with a value 17 in the outer IP header 214. The value 17 indicates that the data portion of the packet is using the UDP protocol for communication. The GENEVE header 216 encapsulated in the UDP header over either IPv4 or IPv6.

The GENEVE header 216 is a tunnel header that comprises fields including a Variable-Length Option class and a protocol type. The Variable-Length Option class comprises a new GENEVE option class, i.e., a multi-seg-SD-WAN option class to indicate that the multi-segment SD-WAN relevant Sub-TLVs are encoded in the GENEVE header 216. The protocol type includes a value 50 to indicate that the next is the ESP header 222 to process. The GENEVE header 216 is then followed by a set of variable-length options field in a TLV format. Each option consists of a 4-byte option header and a variable amount of option data interpreted according to the type. Here, a new sub-TLV type, i.e., an SD-WAN-Endpoint sub-TLV 218 is described to indicate the destination of the IPsec Tunnel. For example, the SD-WAN-Endpoint sub-TLV 218 has the address of CPE10. In an embodiment, for the multi-segment SD-WAN via cloud backbone scenario as shown in FIG. 2B, the originator CPE1 may use an Egress GW sub-TLV to specify the egress cloud GW for reaching the destination CPE10. In an embodiment, the originator CPE1 can use SD-WAN Tunnel Origin Endpoint sub-TLV to indicate the originating CPE of the IPsec Tunnel. The SD-WAN Tunnel Origin Endpoint sub-TLV in the GENEVE header can assist cloud transit nodes in applying appropriate policies when forwarding the packet 200B. However, inclusion of the Egress GW sub-TLV and the Tunnel Origin Endpoint sub-TLV in the GENEVE header are optional. The standard format of the GENEVE header is described in more detail in the IETF document RFC 8926 entitled “Geneve: Generic Network Virtualization Encapsulation” by J. Gross, et al., published November, 2020.

The GENEVE header is then further encrypted using the ESP protocol. The ESP header 222 comprises a Security Parameters Index (SPI) field, sequence number field, a payload IP header field, and a TCP header field. The payload IP header field and the TCP header field contain encrypted data. The authentication data 224 is a variable-length field containing an integrity check value (ICV) computed over the ESP packet minus the authentication data. For the sake of brevity, a detailed description of these fields is not repeated herein. The standard format of the ESP header is described in more detail in the IETF document RFC 4303 entitled “IP Encapsulating Security Payload (ESP)” by S. Kent, et al., published December, 2005.

Illustration of Traffic Flow from CPE1 to CPE10 Through the Cloud Backbone

In an embodiment, the sender CPE1 examines the destination address in the outer IP header 214 of the packet header 200B, consults its routing table to determine the next hop, and forwards the packet to the cloud GW 118 via IPsec tunnel 120 as shown in FIG. 1B. In an embodiment, upon receiving the GENEVE encapsulated packet with the GENEVE Protocol Type=50 (ESP), the cloud GW 118 authenticates the packet using a preconfigured authentication method. After authentication, the cloud GW 118, terminates the outer IP header 214 and checks the address encoded in the SD-WAN Endpoint sub-TLV 218 inside the GENEVE header 216.

In an embodiment, the cloud GW 118 makes decision whether to forward the packet to another Cloud GW or forward directly to the destination CPE based on the address encoded in the SD-WAN Endpoint sub-TLV 218. When the cloud GW 118 makes the decision to send the packet directly to the destination CPE2, the cloud GW 118 forwards the IPsec encapsulated packet from CPE1 to the CPE2.

In another embodiment, when the cloud GW 118 makes the decision to send the packet the second cloud GW 124 or when the cloud operator's internal policy determines that another transit node is required, the cloud GW 118 determines whether an Egress-GW sub-TLV is present in the GENEVE Header. In one embodiment, when the Egress-GW sub-TLV is present in the GENEVE Header, cloud GW 118 proceeds to 1) Constructs a cloud backbone's internal encapsulation header which can be GENEVE or cloud backbone's proprietary encapsulation header, 2) Extracts the destination address of the cloud backbone encapsulation header from the Egress-GW sub-TLV i.e. a destination address of an Egress-GW (e.g., cloud GW2), and 3) Forwards the packet with the Cloud Backbone's internal Encapsulation Header to the Egress-GW. In an embodiment, the cloud Backbone's Encapsulation Header can construct its own or optionally include the original outer header sent from the originating CPE (i.e., CPE1). In an embodiment, the Egress-GW removes the cloud Backbone Encapsulation Header and sends the IPsec encapsulated packet from CPE1 to the CPE2. The process and policy of selecting the next cloud GW/transit node is internal to the cloud operator. The GENEVE header 216 remains unchanged.

In an embodiment, the source CPE1 may specify a list of logical cloud GWs/transit nodes. Those logical transit nodes don't have to be directly connected. There may be multiple cloud internal transit nodes which are not visible to CPEs.

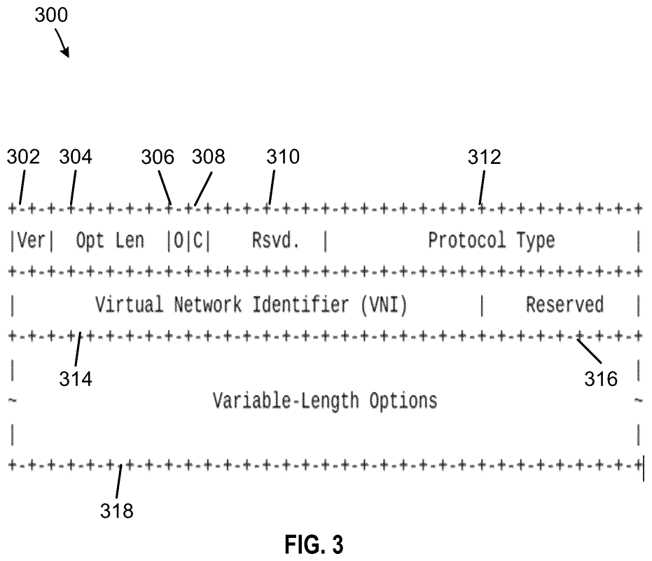

FIG. 3 is a schematic diagram illustrating a format of a GENEVE header 300 according to an embodiment of the present disclosure. The GENEVE header 300 comprising a version field 302, an Opt Len field 304, an O field 306, a C field 308, a Rsvd field 310, a protocol type field 312, a Virtual Network Identifier (VNI) field 314, a Reserved field 316, and variable length options field 318. The version field 302 refers to a version information of the GENEVE header 300. The Opt Len field 304 refers to the length of variable length options field 318. The O field 306 refers to the OAM packet and contains a control message. The C field 308 refers to critical options present. The Rsvd field 310 refers to a reserved field set zero on transmission and ignored on receipt. The protocol type field 312 refers to the type of the protocol data unit appearing after GENEVE header 300. For example, as shown in FIG. 2, the GENEVE header 202 contains the value 50 in its Protocol type field indicating that the next is the ESP header to process. The VNI field 314 refers to an identifier for a unique element of a virtual network. The Reserved field 316 refers to a reserved field set zero on transmission and ignored on receipt. The variable length options field 318 presents in a Type-Length-Value (TLV) format. Each option consists of a 4-byte option header and a variable amount of option data interpreted according to the type. For example, as shown in FIG. 2A or FIG. 2B, the GENEVE header 202 followed by a new sub-TLV, i.e., an SD-WAN-Endpoint Sub-TLV indicating the destination of the IPsec Tunnel. For example, the SD-WAN-Endpoint sub-TLV 208 has the address of CPE2 as shown in FIG. 2A and the SD-WAN-Endpoint sub-TLV 218 has the address of CPE10 as shown in FIG. 2B. The GENEVE header is described in more details in the IETF document RFC 8926 entitled “Geneve: Generic Network Virtualization Encapsulation” by J. Gross, et al., published November, 2020.

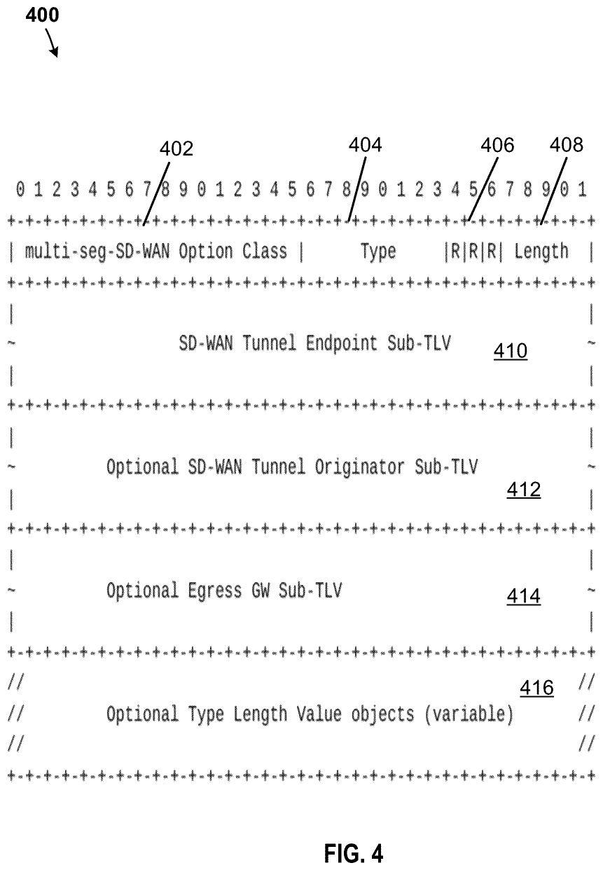

FIG. 4 is a schematic diagram illustrating a format 400 of multi-segment SD-WAN option class according to an embodiment of the present disclosure. As shown, the format 400 includes an options field 402, a type field 404, a R field 406, a length field 408, and a variable-length option data field. The options field 402 includes a new GENEVE option class, i.e., a multi-seg-SD-WAN option class indicating that the multi-segment SD-WAN relevant Sub-TLVs are encoded in the GENEVE header. The type field 404 indicates the format of the data contained in the options field 402. The type field 404 indicates the various types of multi-segment SD-WAN. For example, the type field 404 with value 1 indicates a single hop transit SD-WAN, the type field 404 with value 2 indicates multi-hop transit SD-WAN with explicitly specified egress cloud GW, and the type field 404 with value 3 indicates multi-hop transit SD-WAN without specified egress cloud GW. The R field 406 of 3 bits and indicates control flags reserved for future use. The R field 406 may be zero on transmission and ignored on receipt. The length field 408 indicates length of the options field 402. The variable-length option data field may be interpreted according to the type field 404. The variable-length option data field may include SD-WAN Tunnel Endpoint sub-TLV type 410 and/or multiple optional sub-TLVs such as SD-WAN Tunnel Originator sub-TLV type 412, Egress GW sub-TLV 414, and optional TLV objects (variable) 416. These GENEVE options are primarily intended to be originated and processed by tunnel endpoints (e.g., CPEs). However, options may be processed by transit devices/Cloud GWs along the tunnel path as well.

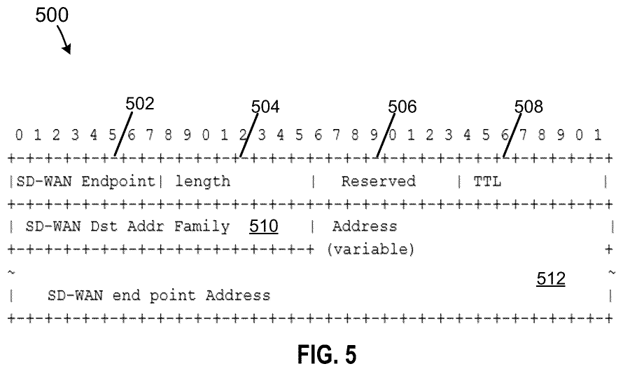

FIG. 5 is a schematic diagram illustrating a format 500 of a SD-WAN endpoint Sub-TLV according to an embodiment of the present disclosure. As shown, the format 500 includes an SD-WAN endpoint field 502, a length field 504, a reserved field 506, a Time to live (TTL) field 508, a SD-WAN Dst Addr family field 510, and a SD-WAN point address field 512. The SD-WAN endpoint field 502 indicates the destination CPE of the IPsec Tunnel. For example, as shown in FIG. 2A, for the SD-WAN IPsec SA from CPE1 to CPE2, the Tunnel Endpoint Sub-TLV 208 of the GENEVE Header 206 has the CPE2's IP address. The TTL field 508 is set by the SD-WAN Tunnel originator, e.g., CPE1. Each transit node or transit region/zone (i.e. visible to the CPEs) can decrement the TTL field 508 such that the destination CPE can know the number of logical transit nodes (cloud regions or zones) the packet has traversed. Enterprises can also use TTL field 508 to set the maximum transit nodes/regions the packets traverse.

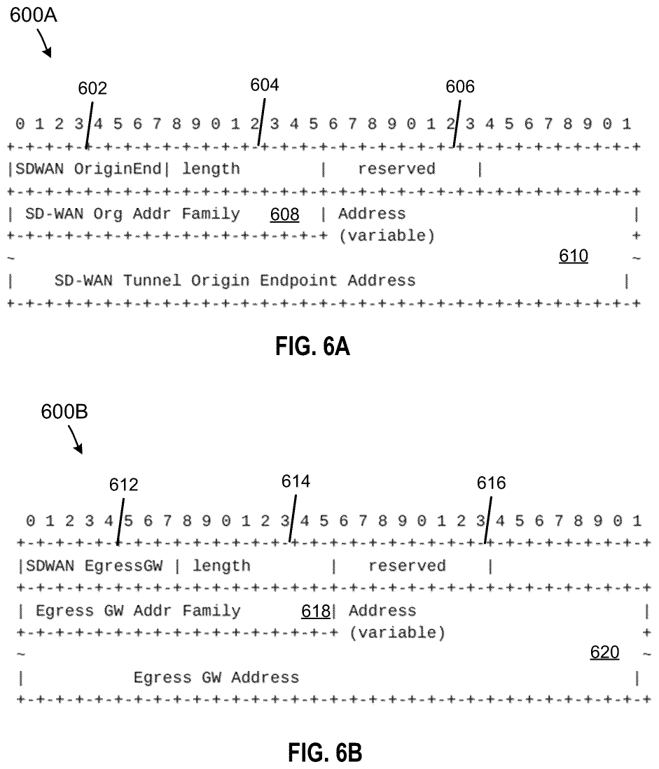

FIG. 6A is a schematic diagram illustrating a format 600A of a SD-WAN tunnel origin endpoint Sub-TLV according to an embodiment of the present disclosure. As shown, the format 600 includes an SD-WAN OriginEnd field 602, a length field 604, a reserved field 606, a SD-WAN Org Addr family field 608, and a SD-WAN tunnel origin endpoint address field 610. The SD-WAN OriginEnd field 602 indicates the originating CPE of the IPsec Tunnel. For example, for the SD-WAN tunnel between CPE1 and CPE10, the Tunnel Originating Sub-TLV of the GENEVE Header indicates the address to CPE1. The Tunnel Origin Endpoint Sub-TLV in the GENEVE header can assist cloud transit nodes in applying appropriate policies when forwarding the packet. However, including the Tunnel Origin Endpoint Sub-TLV in the GENEVE header is optional.

FIG. 6B is a schematic diagram illustrating a format 600B of a SDWAN Egress GW Sub-TLV according to an embodiment of the present disclosure. As shown, the format 600B includes an SDWAN Egress GW field 612, a length field 614, a reserved field 616, an Egress GW Addr family field 618, and an Egress GW address field 620. For the multi-segment SD-WAN via Cloud Backbone scenario, the originator CPE can use the Egress GW Sub-TILV to specify the Egress Cloud GW for reaching the destination CPE.

### Control Plane Implementation in SD-WAN

Control plane for CPEs: Disclosed herein are embodiments for control plane implementation in SD-WAN. The control plane enables SD-WAN edges to discover their properties and attached routes. The on-prem CPEs and their virtual CPEs (vCPEs) or virtual Appliances in cloud DCs can be controlled by one internal BGP (iBGP) instance. The IETF document entitled “BGP UPDATE for SD-WAN Edge Discovery” by Linda Dunbar, et al., published October, 2023 describes the mechanism for SD-WAN edges to discover each other's properties. In an embodiment, the IPsec Key Exchange between on premises CPEs and the vCPE occurs via the iBGP Update through RR.

Control plane between CPEs and cloud GWs: In SD-WANs implementing BGP, it is common to establish external BGP (eBGP) sessions between enterprise CPEs and the Cloud GWs. An enterprise-owned vCPE can establish an eBGP session with the cloud VPN GW for accessing the workloads hosted in the Cloud DCs. If an IPsec tunnel is required between the Cloud GW and the vCPE, the IPSec internet key exchange version 2 (IKEv2) has to be exchanged between the vCPE and the Cloud GW.

In some alternative embodiments, in implementing end to end IPsec Tunnel, the packet header may comprise payload and an outer IP header. The payload may comprise Src: C-PE3, Dst: C-PE1, protocol number 6 corresponds to transmission control protocol (TCP) and protocol number 17 corresponds to UDP. The Outer IP header may comprise Src: C-PE3, Dst: C-PE1, protocol number 50 corresponds to ESP, and protocol number 51 corresponds to authentication header (AH). In one embodiment, SR policy is used to ensure that the packets from C-PE3 are steered through the transit node C-PE2. In one embodiment, as the packets are via public internet, digital signature (or HMAC) can be used to verify that the packets a transit node receives have not been tampered with. In another alternative embodiment, when all IPsec Tunnels Terminate at Transit Nodes, the transit node decrypts the payload received and encrypts the payload to the new tunnel. The payload may comprise Src: C-PE3; Dst: C-PE1; protocol number 6 corresponds to TCP and protocol number 17 corresponds to UDP. The Outer IP header may comprise Src: C-PE3; Dst: C-PE2; protocol number 50 corresponds to ESP, and protocol number 51 corresponds to AH. The payload can be encapsulated by GENEVE, which includes the next tunnel identifier.

### Use Cases

Enterprises connecting to cloud DCs may find significant benefits in leveraging the cloud backbone for transporting traffic between the CPEs. These benefits include: 1) leveraging the robust and high-performance infrastructure provided by cloud service providers, utilizing diverse paths and harnessing scalability and global reach of cloud backbones to reduce the risk of downtime or disruptions, 2) accommodating increased data traffic efficiently due to the scalability of the cloud backbone, 3) simplifying network administration through centralized management and orchestration capabilities of the cloud backbone, enabling organizations to streamline operations and respond effectively to changing business requirements, 4) providing the network paths from CPEs to the cloud GW with more reliable connections and are constantly monitored by sophisticated network functions in comparison to the public internet among those branches might have limited bandwidth, unpredictable connection, or be prone to cyber-attacks, 5) providing ease to utilize cloud based security functions, such as Firewall, Distributed Denial of Service (DDoS), etc., to apply consistent policy enforcement for workloads/services to the cloud and across the branches, and 6) providing ease to utilize cloud-based tools and Software as a Service (SaaS) to collect and analyze the threat of traffic.

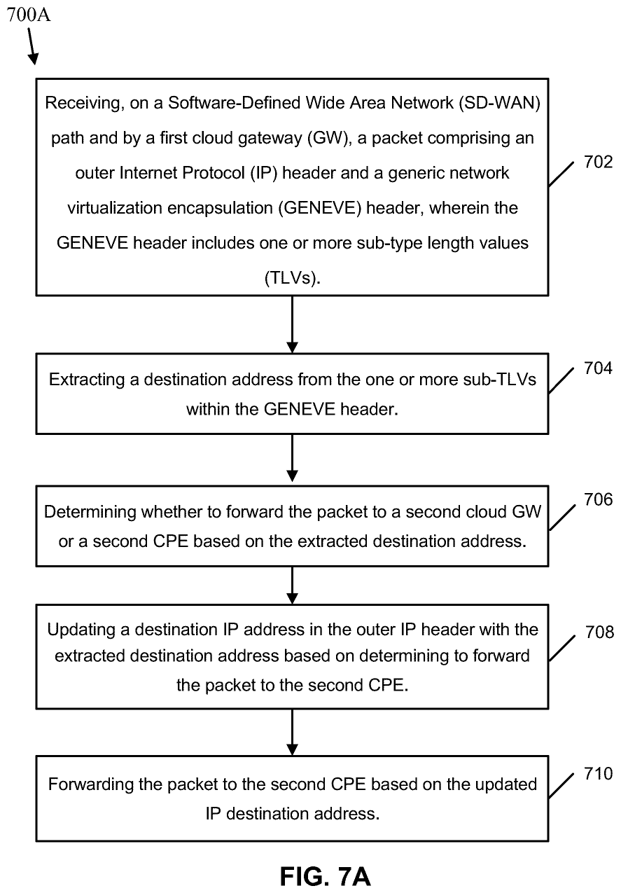

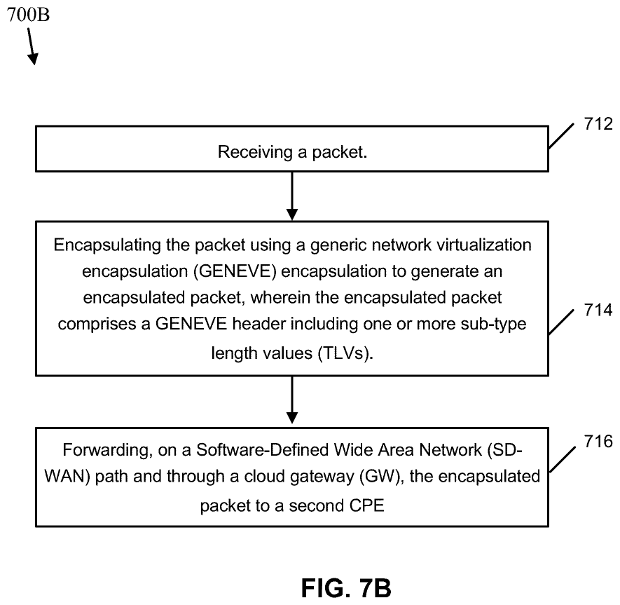

FIG. 7A is a flowchart illustrating a method 700A to optimize the stitching of multiple SD-WAN segments on transit nodes across cloud DCs according to an embodiment of the present disclosure. The method 700 may be implemented by a first cloud gateway (GW) (e.g. cloud gateway 118) in a SD-WAN network (e.g., network 100A, 100B).

In block 702, the first cloud gateway receives, on a SD-WAN path, a packet comprising an outer Internet Protocol (IP) header and a generic network virtualization encapsulation (GENEVE) header, wherein the GENEVE header includes one or more sub-type length values (TLVs). In an embodiment, the one or more sub-TLVs comprise a SD-WAN Endpoint sub-TLV, and wherein the SD-WAN Endpoint sub-TLV comprises a destination address of a second CPE.

In block 704, the first cloud gateway extracts a destination address from the one or more sub-TLVs within the GENEVE header.

In block 706, the first cloud gateway updates a destination IP address in the outer IP header with the extracted destination address.

In block 708, the first cloud gateway forwards the packet to the second CPE based on the updated IP destination address. The method 700 may further comprise when determining to forward the packet to the second cloud GW, determining whether the one or more sub-TLVs include an egress-GW sub-TLV; extracting a second destination address of the second cloud GW from the egress-GW Sub-TLV based on determining the one or more sub-TLVs include the egress-GW sub-TLV; updating a source IP address in the outer IP header with an address of the first cloud GW; and forwarding the packet to the second cloud GW based on the updated source IP address and the second destination address.

FIG. 7B is a flowchart illustrating a method 700B according to an embodiment of the present disclosure. The method 700B may be implemented by a first customer premises edge (CPE), (e.g. CPE 102) in a SD-WAN network (e.g., network 100A, 100B).

In block 712, the first CPE receives a packet. In an embodiment, the packet is an Internet Protocol Security (IPsec) encrypted packet.

In block 714, the first CPE encapsulates the packet using a generic network virtualization encapsulation (GENEVE) encapsulation to generate an encapsulated packet, wherein the encapsulated packet comprises a GENEVE header including one or more sub-type length values (TLVs);

In block 716, the first CPE forwards, on a Software-Defined Wide Area Network (SD-WAN) path and through a cloud gateway (GW), the encapsulated packet to a second CPE. In an embodiment, the one or more sub-TLVs comprise a SD-WAN Endpoint sub-TLV, wherein the SD-WAN Endpoint sub-TLV comprises a destination address of the second CPE.

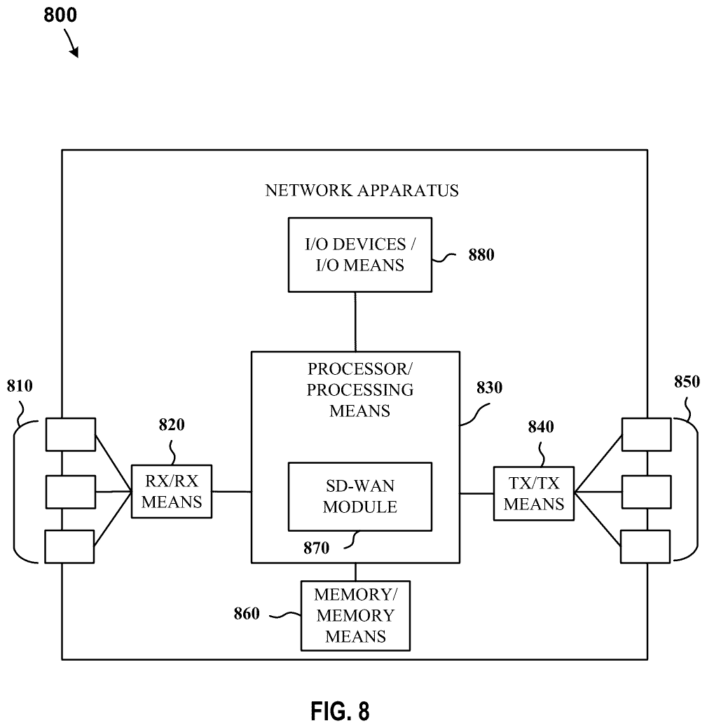

FIG. 8 is a schematic diagram illustrating a network element 800 according to an embodiment of the present disclosure. The network element 800 is suitable for implementing the disclosed embodiments as described herein. The network element 800 comprises ingress ports 810 and receiver units (Rx) 820 or receiving means for receiving data; a processor, logic unit, central processing unit (CPU) 830, or processing means to process the data; transmitter units (Tx) 840 or transmitting means, and egress ports 850 for transmitting the data; and a memory 860 or data storing means for storing the data. The routing device 800 may also comprise optical-to-electrical (OE) components and electrical-to-optical (EO) components coupled to the ingress ports 810, the receiver units 820, the transmitter units 840, and the egress ports 850 for egress or ingress of optical or electrical signals.

The processor 830 is implemented by hardware and software. The processor 830 may be implemented as one or more CPU chips, cores (e.g., as a multi-core processor), field-programmable gate arrays (FPGAs), application specific integrated circuits (ASICs), and digital signal processors (DSPs). The processor 830 is in communication with the ingress ports 810, receiver units 820, transmitter units 840, egress ports 850, and memory 860. The processor 830 comprises a SD-WAN module 870. The network element 800 is able to implement one or more of the embodiments or actions described above. For instance, the SD-WAN module 870 implements, processes, prepares, or provides the various functions disclosed herein. The inclusion of the SD-WAN 870 therefore provides a substantial improvement to the functionality of the network element 800 and effects a transformation of the network element 800 to a different state. Alternatively, the network element 800 is implemented as instructions stored in the memory 860 and executed by the processor 830.

The network element 800 may also include input and/or output (I/O) devices 880 for communicating data to and from a user, and for receiving input from and providing output to a network administrator. The I/O devices 880 may include output devices such as a display for displaying video data, speakers for outputting audio data, etc. The I/O devices 880 may also include input devices, such as a keyboard, mouse, trackball, etc., and/or corresponding interfaces for interacting with such output devices.

The memory 860 comprises one or more disks, tape drives, and solid-state drives and may be used as an over-flow data storage device, to store programs when such programs are selected for execution, and to store instructions and data that are read during program execution. The memory 860 may be volatile and/or non-volatile and may be read-only memory (ROM), random access memory (RAM), ternary content-addressable memory (TCAM), and/or static random-access memory (SRAM).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a first cloud gateway (GW), the method comprising:
receiving, from a first customer premises edge (CPE) on a Software-Defined Wide Area Network (SD-WAN) path, a packet comprising an outer Internet Protocol (IP) header and a generic network virtualization encapsulation (GENEVE) header, wherein the GENEVE header comprises one or more sub-type length values (TLVs);
extracting a destination address from the one or more sub-TLVs within the GENEVE header;
updating a destination IP address in the outer IP header with the extracted destination address; and
forwarding the packet to a second CPE based on the updated destination IP address.

2. The method of claim 1, wherein the one or more sub-TLVs comprise a SD-WAN Endpoint sub-TLV, and wherein the SD-WAN Endpoint sub-TLV comprises the destination address of the second CPE.

3. The method of claim 1, further comprising:
updating a source IP address in the outer IP header with an address of the first cloud GW; and
forwarding the packet to the second CPE based on the updated source IP address and the updated IP destination address.

4. The method of claim 1, wherein before forwarding the packet to the second CPE, the method further comprising determining to forward the packet to a second cloud GW based on policy of a cloud operator.

5. The method of claim 4, further comprising:
determining whether the one or more sub-TLVs comprise an egress-GW sub-TLV;
extracting a second destination address of the second cloud GW from the egress-GW Sub-TLV based on determining the one or more sub-TLVs comprise the egress-GW sub-TLV;
updating a source IP address in the outer IP header with an address of the first cloud GW; and
forwarding the packet to the second cloud GW based on the updated source IP address and the second destination address.

6. The method of claim 5, wherein the egress-GW sub-TLV indicates an address of the second cloud GW for reaching the second CPE.

7. The method of claim 5, wherein the first cloud GW is in a first cloud data center, and wherein the second cloud GW is in a second cloud data center.

8. The method of claim 1, wherein the packet is an Internet Protocol Security (IPsec) encrypted packet.

9. The method of claim 1, wherein the GENEVE header is encapsulated in a user datagram protocol (UDP) header.

10. The method of claim 1, wherein the GENEVE header further comprises variable length options field, and wherein the variable length options field comprises an option class field, a type field, and a variable options data field.

11. The method of claim 10, wherein the option class field comprises a multi-seg-SD-WAN option class, and wherein the type field indicates a type of multi-segment SD-WAN.

12. The method of claim 10, wherein the variable length options field further comprises the one or more sub-TLVs, wherein the one or more sub-TLVs comprise an SD-WAN Endpoint sub-TLV and optional sub-TLVs, and wherein optional sub-TLVs comprise an SD-WAN tunnel originator sub-TLV and/or an egress GW sub-TLV.

13. The method of claim 12, wherein the SD-WAN Endpoint sub-TLV comprises a length field and a Time to live (TTL) field indicating a number of cloud GWs traversed by the packet.

14. The method of claim 12, wherein the SD-WAN tunnel originator sub-TLV indicates an IP address of the first CPE.

15. The method of claim 1, further comprising performing authentication on the packet using preconfigured authentication methods.

16. A method implemented by a first customer premises edge (CPE), the method comprising:
receiving a packet, wherein the packet is an Internet Protocol Security (IPsec) encrypted packet;
encapsulating the packet using a generic network virtualization encapsulation (GENEVE) encapsulation to generate an encapsulated packet, wherein the encapsulated packet comprises a GENEVE header including one or more sub-type length values (TLVs); and
forwarding, on a Software-Defined Wide Area Network (SD-WAN) path and through a cloud gateway (GW), the encapsulated packet to a second CPE.

17. The method of claim 16, wherein the one or more sub-TLVs comprise a SD-WAN Endpoint sub-TLV, and wherein the SD-WAN Endpoint sub-TLV comprises a destination address of the second CPE.

18. The method of claim 17, further comprising enabling the cloud GW to extract the destination address of the second CPE from the one or more sub-TLVs within the GENEVE header.

19. The method of claim 16, wherein the one or more sub-TLVs comprise an SD-WAN tunnel originator sub-TLV indicating an address of the first CPE or an egress GW Sub-TLV.

20. The method of claim 16, wherein the encapsulated packet further comprises an outer IP header, wherein the outer IP header comprises a destination address indicating an address of the cloud GW, and wherein the method further comprises establishing an Internet Protocol Security (IPsec) tunnel between the first CPE and the second CPE to forward the packet to the second CPE.
